(19) United States
(12) Patent Application Publication
(10) Pub. No.: US 2004/0195356 A1
(43) Pub. Date: Oct. 7, 2004

(54) Crop spraying device

(76) Inventor: Mark Ellsworth, Tempe, AZ (US)

Correspondence Address: SCHMEISER OLSEN & WATTS, 18 E UNIVERSITY DRIVE, SUITE # 101, MESA, AZ, 85201

(21) Appl. No.: 10/290,567

(22) Filed: Nov. 7, 2002

(51) Int. Cl. B05D 1/00

(52) U.S. Cl. 239/166

(57) ABSTRACT

The crop spraying device of the present invention is disclosed herein comprises a crop sprayer boom on a pendulum wherein the pendulum pivot is attached to a moving vehicle. The crop sprayer boom may comprise a center section with a spray boom attached on either side. The pendulum arm length is selected or adjusted to produce a natural frequency of pendulum oscillation that is not harmonic with the principal modal frequencies of the crop sprayer boom structure or its principal components. The length of the pendulum arm may be adjustable. The pendulum arm length may be selected to avoid harmonics of the modal vibrations of the sprayer boom when dry, when the spray lines are full, and when the spray heads on the boom are spraying. In a particular embodiment, harmonics of the principal frequencies of the vehicle suspension, sprayer tank slosh, and sprayer pump are also avoided. An apparatus for adjusting the pendulum length without changing the height of the boom above the crop is included in the disclosure. The spray booms may be tilt-biased together or independently, using a fluid transfer system. An apparatus for compensating the effective physical pendulum arm length to maintain a constant pendulum frequency after tilt-biasing is disclosed. A method of determining boom oscillation frequencies without resorting to extensive structural analysis is also included in the disclosure.

### BACKGROUND OF THE INVENTION

1. Technical Field

This invention generally relates to a crop spraying device, and more specifically relates to a pendulum spray boom that does not oscillate out of control.

2. Background

A pendulum crop spraying boom comprises a long structure made of triangular and rectangular arrangements of struts. The boom swings on a pendulum that has its base on a moving vehicle. As the vehicle rolls slightly, the boom remains level or at a predetermined angle. The mass of the boom is conventionally large compared to the mass of the pendulum arm, so the period and frequency of the pendulum are determined primarily by the length of the pendulum arm.

Pendulum crop spraying booms are known in the art. For example, U.S. Pat. No. 3,731,879 to Dijkhof (May 8, 1973) discloses a pendulum boom that can be adjusted as to angle to the horizontal with mechanical trim weights. U.S. Pat. No. 6,131,821 discloses a pendulum boom that is adjusted as to angle to the horizontal with push-pull rods. Both the previously mentioned patents disclose folding the booms for transport. U.S. Pat. No. 6,234,407 B1 to Knight, et al., discloses a damped pendulum boom with hydraulic angle control.

To achieve the greatest economy, a crop sprayer boom must do three things: 1) extend outward from the sprayer vehicle as far as possible; 2) remain very close to the crop; and 3) maintain the desired spray pattern. Maximum extension maximizes the area covered in each trip across the field. Against the need for longer booms, the problem of controllability arises. Longer booms tend to oscillate, and booms on pendulums may oscillate catastrophically. Oscillations can cause the tip of the boom to impact the crop or the ground, causing damage to the crop and the boom, and generating additional oscillations. Furthermore, oscillation disrupts the spray pattern, causing portions of the crop to be inadequately sprayed and expensive spray to be wasted and possibly to drift off the field and cause environmental problems. Controllability issues also arise at the end of the row, where the vehicle and its crop spraying apparatus must turn to make the next pass across the field. Maintaining stability during a turn is a significant problem with long pendulum booms, often requiring the operator to stop and manually adjust the boom multiple times in one turn.

Therefore, there exists a need for a crop-spraying device with a longer pendulum crop spraying boom that has improved controllability, especially in response to maneuvering and impacts.

### SUMMARY OF THE INVENTION

The crop spraying device disclosed herein is a crop sprayer boom on a pendulum wherein the pendulum pivot is attached to a moving vehicle. The crop sprayer boom may comprise a center section with a spray boom attached on either side. The pendulum arm length is selected or adjusted to produce a natural frequency of pendulum oscillation that is not harmonic with the principal modal frequencies of the boom structure or its principal components. The length of the pendulum arm may be adjustable. The pendulum arm length may be selected to avoid harmonics of the modal vibrations of the sprayer boom when dry, when the spray lines are full, and when the spray heads on the boom are spraying. In a particular embodiment, harmonics of the principal frequencies of the vehicle suspension, sprayer tank slosh, and sprayer pump are also avoided. An apparatus for adjusting the pendulum length without changing the height of the boom above the crop is included in the disclosure. The spray booms may be tilt-biased together or independently, using a fluid transfer system. An apparatus for compensating the effective physical pendulum arm length to maintain a constant pendulum frequency after tilt-biasing is disclosed. A method of determining boom oscillation frequencies without resorting to extensive structural analysis is also included in the disclosure.

### BRIEF DESCRIPTION OF THE DRAWINGS

FIG. 1A shows an exemplary embodiment of the crop spraying device;

FIG. 1B shows an exemplary embodiment of the crop spraying device having asymmetrical spray booms;

FIG. 1C shows an exemplary embodiment of the crop spraying device remaining level in response to vehicle roll;

FIG. 1D shows an exemplary embodiment of the crop spraying device in a tilt-biased position;

FIG. 2 shows an exemplary embodiment of the crop spraying device in a side elevation view;

FIGS. 3A-3E show exemplary components of an exemplary embodiment of the crop spraying device;

FIG. 4 shows an exemplary adjustable pendulum arm sleeve and an exemplary adjustable mast sleeve, which may move in a coordinated fashion;

FIG. 5A shows an exemplary articulated spray boom;

FIG. 5B shows an exemplary articulated spray boom with an exemplary suspension mast and an exemplary suspension cable;

FIG. 6 shows an alternative exemplary method of extending a boom with a suspended extension;

FIG. 7A shows a side view of an exemplary embodiment of a hydraulic apparatus for lifting and lowering the pendulum and boom up and down the mast;

FIG. 7B shows a partial front view of the exemplary embodiment of a hydraulic apparatus for lifting and lowering the pendulum and boom up and down the mast;

FIG. 8 shows an exemplary embodiment of a hydraulic apparatus for locking the boom during transport, turning, and maneuvering;

FIG. 9A shows a front view of an exemplary embodiment of a hydraulically-driven mechanical linkage for folding the booms for transport or storage;

FIG. 9B shows a top view of an exemplary embodiment of a hydraulically-driven mechanical linkage for folding the booms for transport, storage, and field end maneuvering;

FIG. 10A shows an exemplary dual-pendulum embodiment of a crop spraying device; and

FIG. 10B shows an exemplary dual-pendulum embodiment of a crop spraying device with each boom independently tilt-biased.

It should be noted that the figures are not necessarily drawn to scale, and that elements having similar functions may in some cases be labeled using the same reference numerals.

### DETAILED DESCRIPTION OF EMBODIMENTS OF THE INVENTION

When booms oscillate, they oscillate at the modal frequencies of the particular structure. For a given structure, these modal frequencies vary with the mass and mass distribution of the boom. For example, there may be one set of modal frequencies when the sprayer is dry, and another set when the mass of the boom is changed by filling the boom's spray pipes with spray. Generally, the longer and more complicated the boom, the more modal frequencies it will have. (Longer implies additional struts in the truss structure of the boom, leading to additional modal frequencies. With a long boom, oscillations can cause disruption of the spray pattern or boom contact with the crop or the ground. To avoid contact with the crop or the ground, an oscillating boom must be raised higher over the crop, which results in less efficient spray coverage as more spray is lost in the wind. Loss of spray off the crop is a serious environmental concern, whether the spray is a pesticide, herbicide, or fertilizer.

A crop-spraying boom may oscillate uncontrollably if harmonic oscillations are coupled into the crop-spraying boom or sections thereof. The initial excitation may be from an impact force that causes the boom to “ring” at its modal frequencies. Those modal frequencies may then excite elements of the crop-spraying device which have modal or natural frequencies harmonic to the impact ringing. Damping is not a panacea for this problem for two reasons. First, passive damping focuses on particular frequencies or frequency bandwidths. In crop-spraying devices, the frequencies that are problematic may change over the course of spraying a single field because mass property changes (i.e., spray usage, tilt biasing) change the frequency of important oscillators in the system. Comprehensive passive damping adds unwanted weight to the crop-spraying boom. Secondly, conventional active damping is too expensive and also adds unwanted weight to the crop-spraying boom.

Various pendulum booms may respond to ground impact by oscillating wildly, or by breaking a tip, or by otherwise damaging the boom. These responses are undesirable. Dampers and controllers designed with a focus on normal operation, i.e., controlling the null angle of the boom against tractor motion, sprayer forces, breezes, and hill slope may not respond appropriately to impact forces. The obvious expedient of making the tip flexible is not a solution, as flexibility alone leads to undesired oscillations.

In particular, there is a need for a crop-spraying device that avoids harmonic coupling between the different under-damped oscillators in the crop-spraying system (crop-spraying boom modal vibrations, pendulum frequency, sprayer pump pulse frequency, spray tank slosh frequency, and vehicle suspension frequency, etc.).

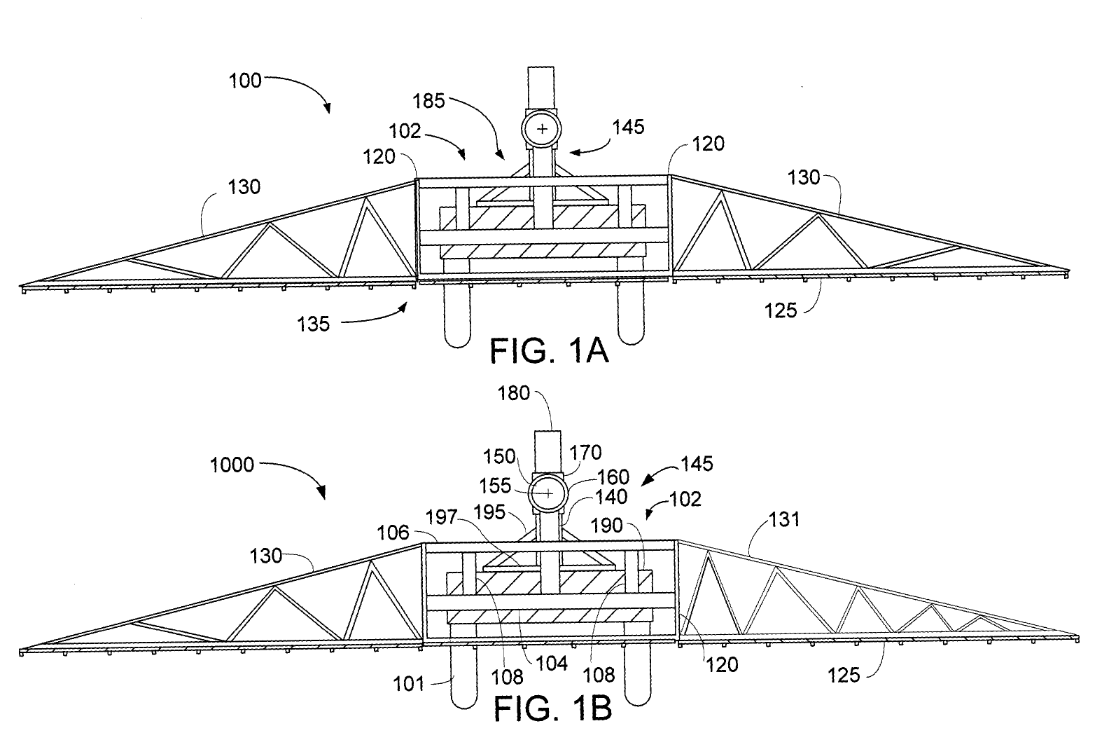

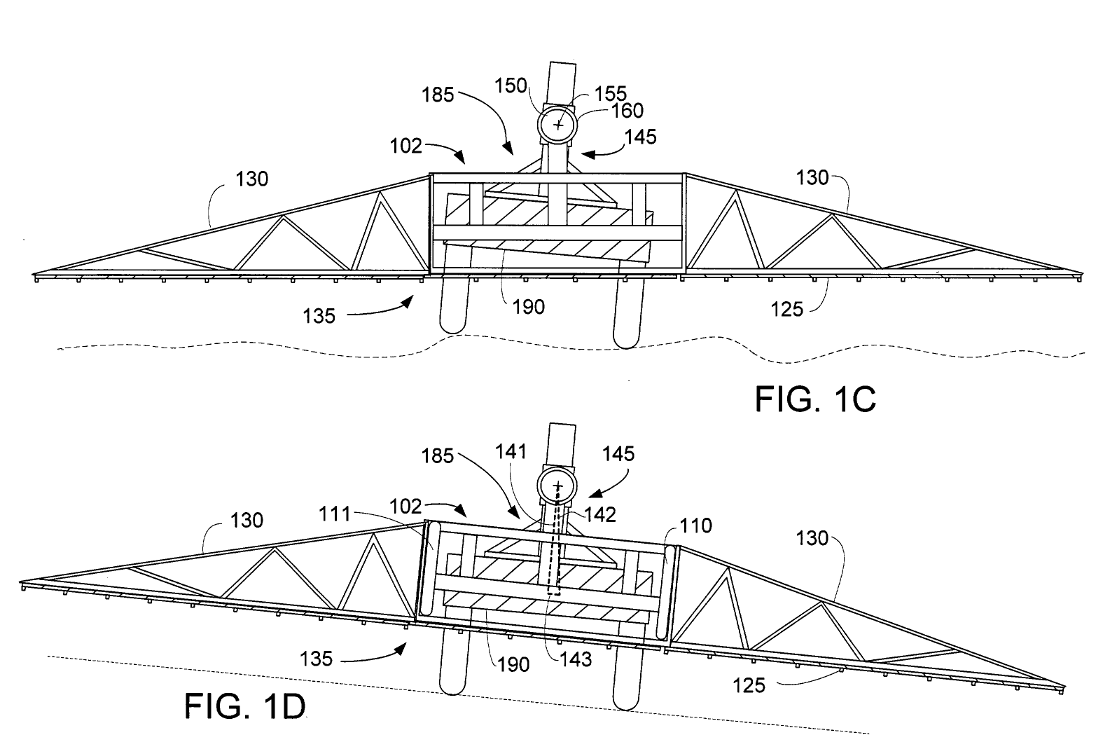

FIG. 1A shows a rear elevation view of the crop spraying device 100. The crop spraying device 100 comprises a pendulum support structure 185, a pendulum arm structure 145, and a boom 135. The boom 135 further comprises a generally rectangular center section 102, the center section 102 further comprising a frame further comprising members 104, 106, and 108. In a particular embodiment, the center section 102 may be of box beam design. The boom 135 further comprises spray booms 130, which may be hinged to center section 102 using hinge pins 120. The hinges may be locked in a plurality of positions. For example, the hinges may be locked with the booms 130 extended as shown, or the hinges may be locked with the booms 130 swung forward, along the sides of vehicle 190, for transport. Spray booms 130 may be mechanically linked to fold forward and to open together to maintain balance. As a matter of physics, spray booms 130 and center section 102 each have modal vibration frequencies characteristic of their structures, and the combination of the center section 102 and the booms 130 may have modal vibration frequencies as well. Among those modal vibration frequencies, there are some which, if harmonically excited, can gain sufficient power to cause loss of control of the boom 135. The problematic frequencies may be called “principal” modal frequencies or under-damped oscillations.

The center section 102, the spray booms 130, hinge pins 120, and the spray plumbing 125 along the center section 102 and along the spray booms 130, comprise the main mass of a pendulum. Referring now to FIG. 1B, the main mass of the pendulum swings upon the pendulum arm structure 145, comprising pendulum arm 140 and pivot sleeve 160. The arm 140 of the pendulum may attach to frame 102 at beam 104 and, at the opposite end of the pendulum arm 140, to the pivot sleeve 160. Pivot sleeve 160 rotates slidingly upon pivot axle 150. The entire pendulum may swing about a pivot axis 155 defined by the longitudinal axis of pivot axle 150. In alternate embodiments, other center section 102 configurations may be used, but still retain coupling of a center section 102 to a pendulum arm 140.

The pendulum length is the length between the pivot axis 155 and the center of mass of the boom 135 and pendulum arm 140. The pendulum length determines the natural frequency of the pendulum (estimating Earth's gravitation as essentially constant). The pendulum length may be selected to produce a natural frequency that is not harmonic with any of the modal vibration frequencies characteristic of the boom 135 or its principal components 130 and 102. This prevents coupling of the natural frequency of the pendulum into the structural vibrations of the spray booms 130, center structure 102 and the boom 135 in its entirety. Such coupling can cause the spray booms 130 or boom 135 to oscillate out of control.

Pivot axle 150 may be a pipe with an outside diameter slightly less than or equal to the inside diameter of the pivot sleeve 160. The pivot sleeve 160 may be retained upon the pivot axle 150 by any conventional mechanism. For example, the pivot axle 150 may have an end plate comprising a threaded rod co-linear with the pivot axis 155, the threaded rod protruding through an aligned opening in an end plate of the pivot sleeve 160, the threaded rod receiving a washer and a lock nut to prevent relative motion of the pivot sleeve 160 and the pivot axle 150 parallel to the pivot axis 155.

Pivot axle 150 is attached to mast sleeve 170, which slidingly engages mast 180. Mast sleeve 170 and mast 180 may have a square cross section, as shown. In other embodiments, other cross sectional shapes may be used. The position of sleeve 170 on mast 180 may be adjustable to raise or lower the boom 135 responsive to the height of a crop to be sprayed. Mast 180 may attached to vehicle 190 through a support structure comprising brace plates 195 and base plate 197. In alternate embodiments, the mast 180 may be attached directly to the vehicle 190. The mast 180, plates 195 and 197, mast sleeve 170, and axle 150 comprise the pendulum support structure 185. In particular alternate embodiments, other mechanisms for lowering and raising the boom 135 may be used.

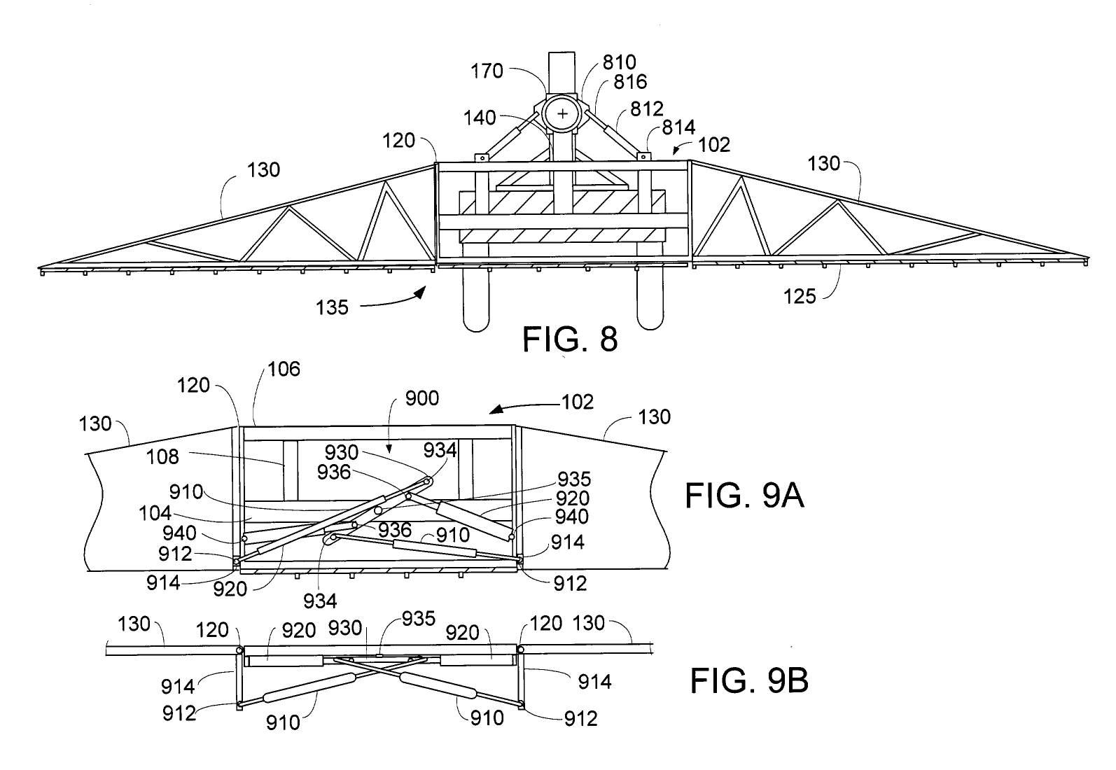

In most embodiments, the pendulum arm 140 may be immobilized for transport, maneuvering, and turns at the end of the field. For example, the pendulum arm 140 may be pinned or chained to the pendulum mast 180, or hydraulically immobilized (See FIG. 8).

In operation, the spray booms 130 and center section 102 support attached spray plumbing 125 while the vehicle 190 is in motion. As the vehicle 190 rolls, the spray booms 130 remain at a fixed orientation with respect to level ground by action of rotation about the pivot axle 150. (See FIG. 1C). Minor oscillations may be damped by frictional losses between the pivot sleeve 160 and the pivot axle 150. The greater the surface area of frictional contact between the pivot sleeve 160 and the pivot axle 150, the greater the damping frictional loss. Thus, the longer the pivot axle 150 and the pivot sleeve 160, or the greater their respective diameters, the greater the damping. Too much frictional damping can lead to an undesirable lag in the boom's 135 response to roll. A pivot axle 150 with a length of 12 inches and a diameter of 4 inches has proven adequate. In a particular embodiment, the pivot axle 150 and the roll axis of the vehicle 190 are co-linear. In such an embodiment, excitation forces on the boom 135 due to vehicle 190 roll are minimized. In most embodiments, the pivot axis 155 is at least parallel to the roll axis of the vehicle to minimize torsion on the boom 135. In an alternate embodiment, pivot sleeve 160 rotates freely about pivot axle 150. In yet another embodiment, a viscous grease is applied between pivot axle 150 and pivot sleeve 160 to provide viscous rotational damping. Pivot damping, as just described, has the advantage of adding no appreciable weight to the crop-spraying boom 135.

FIG. 1B shows an alternate embodiment of the crop-spraying device wherein the spray booms 130 and 131 have different modal vibration frequencies, as illustrated by different strut patterns in the truss of the spray booms 130 and 131. In this alternate embodiment, each spray boom 130 or 131 acts as a damper for the other. Thus, if spray boom 130 rings at 3 Hertz, but spray boom 131 does not, then a 3 Hertz oscillation in spray boom 130 transmitted through center section 102 to spray boom 131 will be damped by the non-harmonic response of spray boom 131. The spray booms 130 and 131 are preferably of equal mass.

FIG. 1C shows the boom 135 remaining level as the vehicle 190 rolls in response to rough ground, represented by the dashed line. If the pivot axis 155 is not co-linear with the roll axis of the vehicle 190, vehicle rolling may induce undesired side-to-side swinging of the boom 135. If the pivot axis 155 is not parallel with the roll axis of the vehicle 190, vehicle rolling may induce undesired torsion about the pendulum arm structure 145. Damping between the pivot sleeve 160 and the pivot axle 150 will reduce the effects of pivot axis 155 misalignment.

FIG. 1D shows the boom 135 with a tilt bias created by transferring fluid into tube 110 from tube 111 in order to shift the center of mass of the boom 135 to the right. By transferring fluid between tubes, a given mass of fluid has more of a biasing effect than shifting two counterweights of similar total mass, as is known in the art. Tubes 110 and 111 may be attached to the center section. The location of the original boom 135 center of mass is indicated in FIG. 1D with a dotted line 141 from the pivot axis, straight down the pendulum arm structure 145 to the center of mass of the boom. The length of line 141 defines the unbiased pendulum length. The shifted center of mass is indicated by dotted line 142 from the pivot axis to the shifted center of mass. The length of line 142 defines the pendulum length in the tilt-biased position. Line segment 143 defines the extent of the shift of the center of mass due to the fluid transfer. Line 142 is the hypotenuse of the triangle formed by lines 141-143. Line 142 is necessarily longer than 141 and so indicates a change in the pendulum length as a result of tilt biasing. A change in pendulum length creates a change in pendulum frequency.

To avoid unwanted changes in the pendulum frequency during tilt-biased operations, the position of the center section 102 on the pendulum arm 140 may be made adjustable, so that the distance from the pivot axis 155 to the coupling with the center section 102, (the effective physical pendulum arm length), may be changed. During tilt-biased operations, a change in the pendulum length may be compensated for by a change in the effective physical pendulum arm length. That is, when the pendulum length is increased by tilt biasing, it may be shortened back to the un-tilt-biased length by moving the position of the coupling up the pendulum arm 140. This may be done manually or by automatic control.

The tubes 110 and 111 may be at any orientation, but the vertical orientation minimizes slosh within the tubes 110 and 111. Placing the tubes 110 and 111 at the ends of the center section maximizes the torque exerted by the fluid mass without putting tubes 110 and 11 on the spray booms 130. The center section 102 is usually sturdier than the spray booms 130, whose weight is kept to a minimum. Additionally, boom stability is improved if the mass of the boom is concentrated below the pivot, i.e., the boom moment of inertia is maximized. In an alternate embodiment, the tubes 110 and 111 are attached to the spray booms 130. In another alternate embodiment, the tubes 110 and 11 are curved with the curvature of a circle about the pivot axle 155 and each half-filled with a viscous fluid to provide viscous damping of rotations about the pivot axis 155. At least one ball of smaller diameter than the inside diameter of the tube may be inserted into the viscous fluid in each of the tubes 110 and 111 to provide passive rotational damping with very little additional weight on the crop-spraying boom 135.

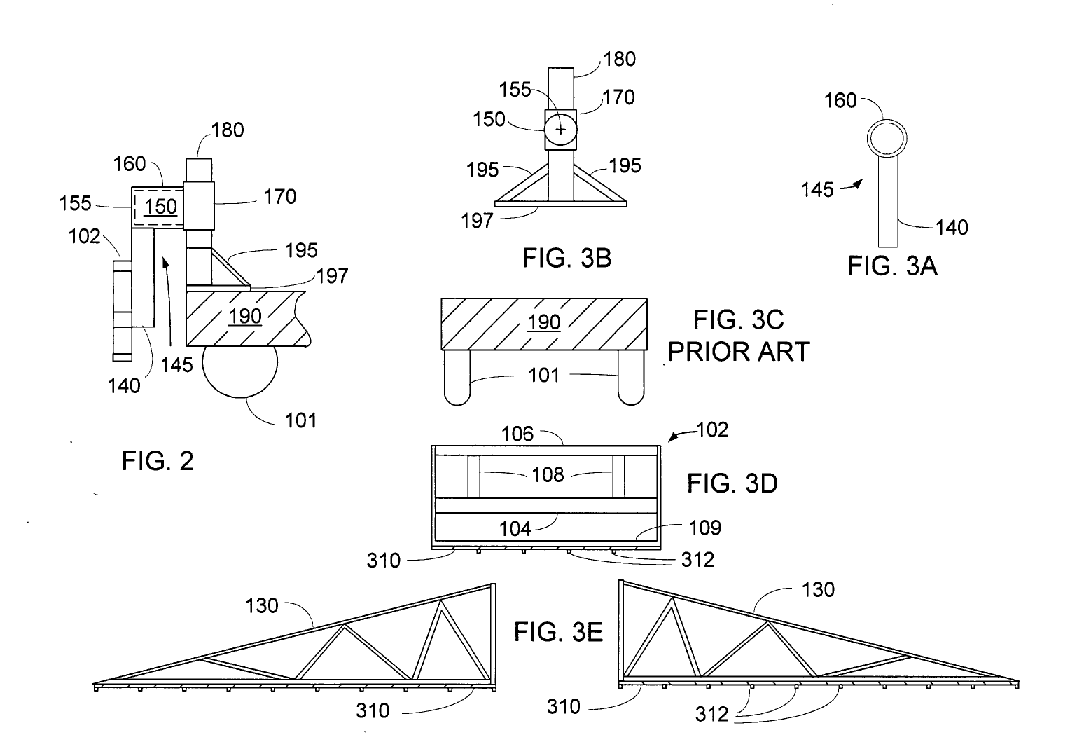

FIG. 2 shows a side elevation view of an embodiment of the crop spraying device mounted on a wheeled 101 vehicle 190. Mast 180 may be supported by plates 195 and plate 197. Attachment to the vehicle 190 may be by bolts through base plate 197 and the vehicle 190. Mast sleeve 180 may be adjusted as to height on mast 180. Pivot axle 150 extends from mast sleeve 170, and is rotationally engaged by the pivot sleeve 160 of the pendulum arm structure 145. Pendulum arm 140 depends from the pivot sleeve 160 to engage the center section 102 of the boom 135 (see FIG. 1B). Mast 180 and the mast sleeve 170 may be of any cross-sectional shape, but are rectangular in cross-section in most embodiments.

FIGS. 3A-3E show the principal parts of the crop-spraying device and a portion of a wheeled 101 vehicle 190. FIG. 3A shows the pendulum arm structure 145, comprising the pendulum arm 140 coupled to pivot sleeve 160. The inside diameter of the pivot sleeve 160 is adapted to fit slidingly on the pivot axle 150 (FIG. 3B). The pendulum arm 140 is fixed to pivot sleeve 160 in most embodiments, but other couplings are possible. For example, in an alternate embodiment, pendulum arm 140 may be releasably attached to pivot sleeve 160. FIG. 3B shows the pendulum support structure 185, comprising the vertical mast 180, mast sleeve 170, axle 150 defining axis of rotation 155, support members 195 and base plate 197. In an alternate embodiment, the base plate 197 may be absent, and the mast 180 and support members 195 may attach directly to vehicle 190. The mast sleeve 170 may be adjustable as to its vertical position on mast 180. The adjustment may be manual or motorized and continuous or discrete. For example, clamps, pins, or even wedges may be used to maintain an adjusted position of the mast sleeve 170 on mast 180.

FIG. 3C shows a diagram of a portion of a prior art vehicle 190 with wheels 101. Any type of ground vehicle 190 may be used, including tractors, tracked vehicles, and trucks. Likewise, vehicles such as boats and air boats, used for marsh crops such as rice and cranberries, may be used to support a crop spraying device. On embodiments adapted to be used with boats, the weight of all portions of the crop-spraying device should be minimized, making harmonic vibration coupling an even more critical issue.

FIG. 3D shows center section 102, comprising beams 106, 108, and 104, as well as spray plumbing section 310 having spray nozzles 312 and plumbing support member 109. In some embodiments, plumbing support member 109 and spray plumbing 310 are not part of the center section 102, and may be attached to the vehicle 190 or may be absent entirely. For example, in a narrow vehicle 190 in which the spray pattern permits the inboard spray nozzles (for example, 312) of the spray booms 130 to cover the area behind vehicle 190, spray nozzles in the center section 102 may not be needed. For further example, in a very large crop-spraying device, the vehicle 190 may move along paths between fields, extending the spray booms 130 over the crops of two different fields, and having nothing to spray beneath the vehicle 190. In embodiment 100, the center section 102 extends horizontally beyond the sides of the vehicle 190 to allow folding the spray booms 130 for transport, storage, and maneuvering; supports the load of the spray booms 130 in operation; and is attachable to the pendulum arm 140. The sides of center section 102 are adapted to flexibly connect with spray booms 130. In most embodiments, the spray booms 130 fold forward for transport and storage. In other embodiments, the spray booms may fold backwards, upwards, or have multiple folds. Articulated spray booms 130 that fold backward at the hinges 120 on the center section 102 and forward at articulation points on the spray booms 130 show excellent stability in maneuver and transport. The spray booms 130 may be linked mechanically to provide that both spray booms 130 fold in concert, thereby avoiding an imbalance on the vehicle 190 and on the pendulum itself (See FIGS. 9A-9B).

Center section 102 may also provide support for a tilt-biasing counterweight mechanism. (See FIG. 1D). The tilt-biasing counterweight mechanism may use pumped fluids to shift the center of mass of the boom 135 to achieve a tilt of boom 135 adapted to a sloped field of crops. In alternate embodiments, spray booms 130 may support tilt-biasing counterweights.

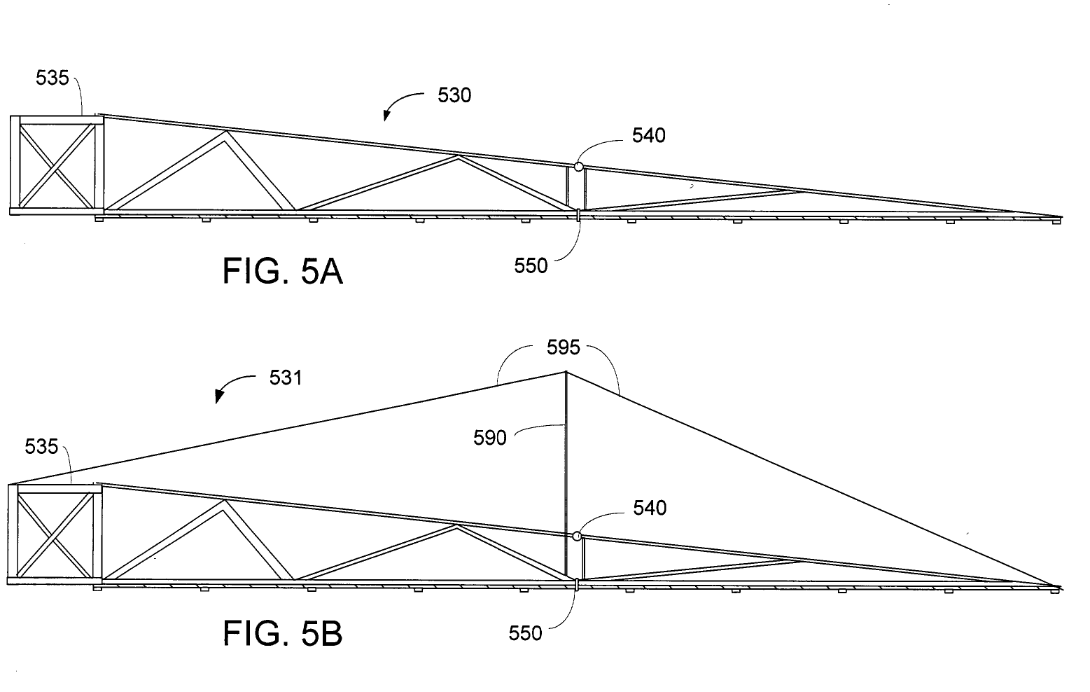

FIG. 3E shows two spray booms 130, comprising generally triangular trusses which supports spray plumbing sections 310 having spray nozzles 312. Other truss shapes are also contemplated. For example, in an embodiment, the truss may have a rectangular portion proximate the center section (See FIG. 5A and 5B). In another embodiment, spray booms 130 may comprise suspension masts and cables. (See FIG. 5B). In yet another embodiment, spray booms 130 may be made of articulated sections that fold for transport or storage (See FIG. 5A and 5B). The trusses may be simple trusses, box-beam trusses, or other truss types known in the art. Trusses having few principal modal frequencies are preferred.

The apparatus described so far presents a fixed solution to the problem of coupling pendulum oscillations into the boom 135. Two classes of problems remain to be addressed: variable solutions to the pendulum-boom coupling problem and other coupled oscillators in the system.

There are two situations in which the pendulum length may change. The first situation is where the length of the pendulum arm 140 is an adjustable length. Such a pendulum arm 140 may be adapted to attach to a sequence of different crop-spraying booms 135, one after another, and be adjusted to avoid the harmonic frequencies of each crop-spraying boom 135 in turn. The second situation is where the center of mass of the crop-spraying boom 135 is shifted to one side to achieve an off-level tilt angle for the crop-spraying boom 135 adaptive to a sloping field of crops. A fluid-transfer counterweight system may be used for this purpose. Note that a change in pendulum length may be achieved this way even though the pendulum arm 140 has a fixed length. Once the sprayer center of mass is shifted to the side, the pendulum length no longer runs from the pivot axis 155 straight down the pendulum arm 140 to the center of mass of the boom 135. Rather, the new pendulum length is the hypotenuse 142 (FIG. 1D) of the triangle formed by the original pendulum length 141 (FIG. 1D) and the distance to the new center of mass 143 (FIG. 1D). Because the pendulum length is changed by tilt-biasing the boom 135, the possibility that the new pendulum length 142 (FIG. 1D) may produce a natural frequency that is harmonic with a principal frequency of the boom 135 or other oscillator must be considered.

Analysis or testing of a range of frequencies corresponding to pendulum lengths should be undertaken to determine problematic pendulum lengths. Pendulum lengths corresponding to principal harmonic frequencies of the crop-spraying boom 135 and its components 102 and 130 may then be avoided by operational constraints. For example, particular ranges of pendulum lengths may not be used with particular booms. For further example, particular pendulum lengths may be avoided as a function of the state of the crop-spraying boom, (i.e., dry, filled spray plumbing 125, or spraying). For further example, particular pendulum lengths may be selected as a function of the state of vehicle 190 oscillators (suspension, spray tank slosh, spray pump, etc.), such as the mass and slosh frequency of the spray in the spray tank. In an embodiment, pendulum lengths corresponding to principal harmonic frequencies of the vehicle 190 oscillators (suspension, spray tank slosh, spray pump, etc.) may be avoided by targeted passive damping of the principal frequencies on the vehicle 190, thereby avoiding the added weight of the dampers on the crop-spraying boom 135.

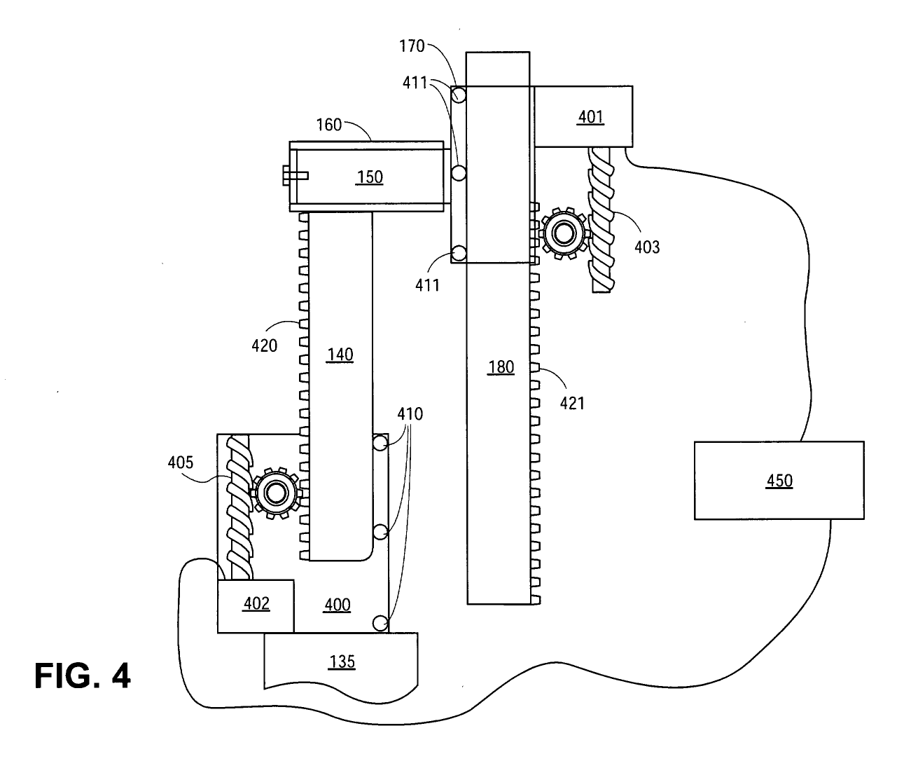

FIG. 4 shows a crop-spraying boom 135 attached to a pendulum sleeve 400. Pendulum sleeve 400 couples the crop-spraying boom 135 to the pendulum arm 140. pendulum sleeve 400 comprises a sleeve that surrounds a portion of pendulum arm 140 circumferentially. In the exemplary embodiment shown in FIG. 4, the pendulum sleeve 400 may surround a toothed rail, or rack, 420 which is attached or integral to the pendulum arm 140. A gear 405, which may be a worm gear 405, is seated on the pendulum sleeve 400 and engages the teeth of the rack 420. The worm gear 405 conventionally comprises a worm and a wheel gear, which may not be to scale in FIG.4. The worm gear 405 may be driven by motor 402 to raise or lower pendulum sleeve 400 and attached boom 135. Rollers 410 are seated in the pendulum sleeve 400 to engage the pendulum arm 140 to maintain the alignment of the pendulum sleeve 400 to the pendulum arm 140.

In an alternate embodiment, the worm gear 402 may be driven by a hand crank. In another alternate embodiment, there may be no rack 4202 and no gear 405, wherein the boom 135 and pendulum sleeve 400 are jacked or hoisted into position on the pendulum arm 140 by external means, and secured in position by clamps, pins, wedges, or similar mechanisms.

Pendulum arm 140 may be fixed to pivot sleeve 160, which may rotationally engage pivot axle 150 (FIG. 1A) which may be fixed to mast sleeve 170. In the embodiment shown in FIG. 4, mast sleeve 170 comprises a vertical slot through which the teeth of rack 421 may protrude at least partially. A gear 403, which may be a worm gear 403, may be externally mounted on the mast sleeve 170 to engage the teeth of rack 421. Motor 401 may drive worm gear 403 to raise or lower mast sleeve 170 and, indirectly, boom 135. Worm gears are preferable because they provide inherent braking. If worm gears 403 and 405 are not used, other means of braking sleeve 170 and 400 motion, as are known in the art, may be used. Rollers 411 are seated in the mast sleeve 170 to engage the mast 180 to maintain the alignment of the mast sleeve 170 to the mast 180.

In an alternate embodiment, the worm gear 403 may be driven by a hand crank. In another alternate embodiment, there may be no rack 421 and no gear 403, wherein the mast sleeve 170 may be jacked or hoisted into position on the mast 180 by external means, and secured in position by clamps, pins, wedges, or similar mechanisms.

Vehicles which use crop-spraying devices carry tanks of spray on board. As the tank empties, the mass of the vehicle changes and the oscillation frequency of the vehicle suspension may change, causing harmonic coupling problems between the vehicle suspension and the pendulum or crop-spraying boom 135 during crop-spraying operations. In such a case, it is desirable to change the pendulum length to avoid the troublesome harmonics. However, simply changing the pendulum length will produce an unwanted change in the height of the boom 135 above the crops. The motions of the mast sleeve 170 and the pendulum sleeve 400 may be coordinated using a controller 450, which signals motor 401 to move the mast sleeve 170 in the opposite direction that motor 402 moves the pendulum sleeve 400 and for an equal distance, thereby changing the pendulum length and frequency without changing the height of the crop-spraying boom 135 above the crops. In a simpler embodiment of the controller 450, motors 401 and 402, gears 403 and 405, and racks 420 and 421 are pair-wise substantially identical or controlled to act identically. The power to the electrical motors 401 and 402 is wired in parallel while the motors 401 and 402 have reverse orientations (one pointed up, the other down) as to their right-handed rotational output. When power is applied, the motors 401 and 402 may provide the same amount of motion in opposite directions. In an alternate embodiment, controller 450 may also enable independent movement of the mast sleeve 170 and the pendulum sleeve 400. In another alternate embodiment, the controller 450 may be replaced with a mechanical linkage using a tensioned chain, wheel gears, and a single motor.

For extremely lightweight crop-spraying booms 135, such as carbon fiber fiberglass or boron-epoxy crop-spraying booms 135, the mass of the spray in the spray plumbing 125 (FIG. 1A-1D) may be the predominant mass of the crop-spraying boom 135. Sprayer pump oscillations, driven by, for example, the pulse frequency of a piston pump, may couple into the spray plumbing 125 and then into the boom 135. The coupling may occur mechanically through the spray pumping 125 connections to the crop-spraying boom 135 or indirectly as a pulsation through the spray nozzles 312 creating reaction forces on the crop-spraying boom 135. If the sprayer pump oscillations are harmonic with the principal modal vibration frequencies of the crop-spraying boom 135 or its spray booms 130, damage or loss of control may result. Consequently, a variable speed sprayer pump may be preferred to enable selection of a pump pulse frequency that is not harmonic with the crop-spraying boom 135 or its components. Conversely, a boom 135 design that has no principal modal frequencies at the pump pulse frequency may avoid harmonic coupling of the pump pulse frequency to the crop- spraying boom 135.

FIG. 5A shows a spray boom 530 having a rectangular end 535 proximate a center section 102 (See FIG. 1B). The spray boom 530 further comprises a hinge 540 and a latch with a plumbing disconnect 550 to enable folding the distal end up onto the proximal end for transport or storage. In an alternate embodiment, there may be more than two articulated sections. In other alternate embodiments, the articulation may be about an approximately vertical axis. In variations of an alternate embodiment, the spray booms 130 may articulate about an axis off-vertical by up to 20 degrees, to lift the tips for transport and maneuver. FIG. 5B shows a spray boom 531 comprising a suspension mast 590 and suspension cable 595. The elasticity of suspension mast 590 and cable 595 are factors in determining the modal vibration frequencies of the spray boom 531 and its associated boom 135.

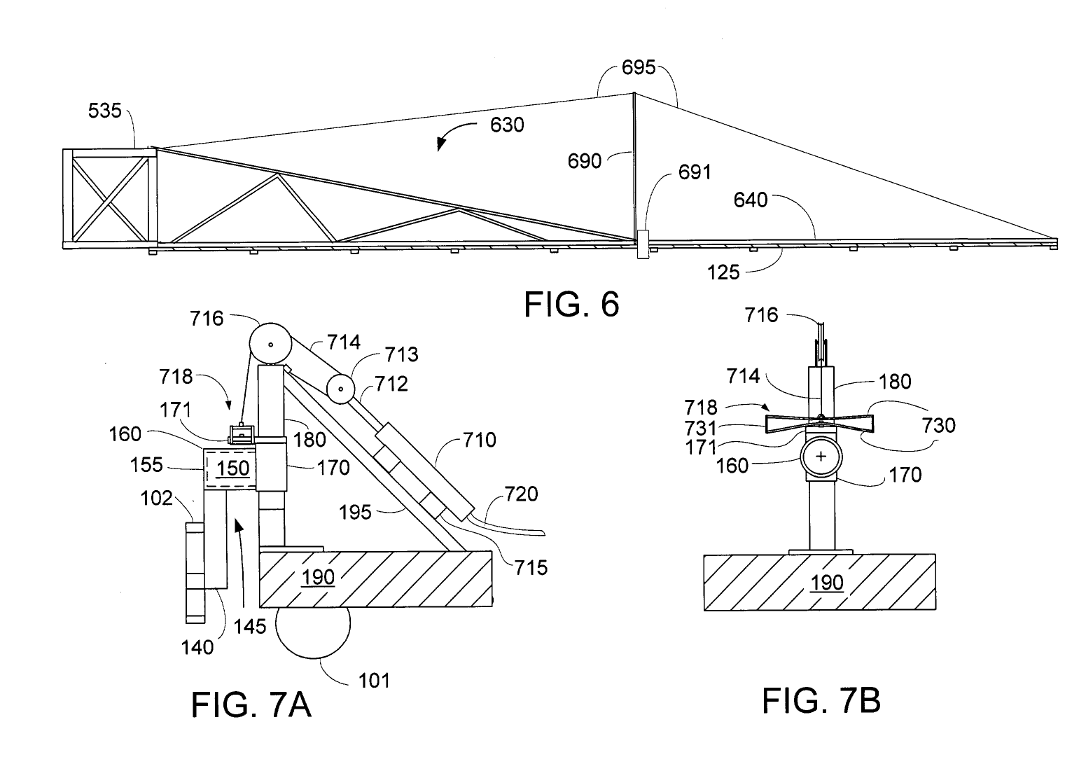

FIG. 6 shows a right-hand spray boom 630 of a pair of spray booms, each having an extension 640 suspended by a cable 695 which is supported by a suspension mast 690. In a particular embodiment, extension 640 may be a pipe and spay plumbing 125 may be integral to that pipe. In another particular embodiment, there may be multiple cables 695, attaching to a plurality of points along extension 640. FIG. 6 also shows a simpler embodiment having a fluid-transfer tilt-biasing mechanism. An inner tube 691 from a small wheel, such as a cart wheel, having an inner diameter enabling engagement around extension 640, may be placed around the extension 640 on left-hand and right-hand booms. Each tube 691 is partially filled with fluid and connected to a transfer pump, mounted on the center section 102 (FIG. 1A), by means of fluid transfer tubing. Fluid may be transferred from tube 691 on the right-hand spray boom 630 to the tube 691 on the left-hand spray boom 630 to establish a tilt bias for the boom 135 (FIG. 1A).

FIG. 7A shows an exemplary embodiment of a crop spraying device with a hydraulic means for adjusting the position of the mast sleeve 170 on the mast 180. Mast support member 195 is shown supporting the top of the mast 180. Attached by brackets 715 to the support member 195 is a hydraulic cylinder 710 operative to activate piston 712. Hydraulic cylinder 710 is supplied with pressurized hydraulic fluid through supply line 720. Piston 712 pulls or releases pulley 713 to tension or release cable 714 to raise or lower pivot sleeve 160 and the attached mast sleeve 170, pendulum arm structure 145, center section 102, and boom 135 (FIG. 1A). The cable 714 runs over a pulley 716 at the top of mast 180 and connects to spring assembly 718 which, in turn, is attached to an extension 171 of mast sleeve 170. Attachment to extension 171 has the advantage of creating a clockwise torque about the mast sleeve 170 to counter the counterclockwise torque created by the mass of the boom 135. This countercockwise torque can cause the mast sleeve 170 to bind to the mast 180 and also cause the pivot sleeve 160 to bind to the pivot axle 150. While such binding may be useful to lock the pendulum when maneuvering, turning, or transporting the crop spraying device, it is undesirable during operations. Thus, lifting directly by the mast sleeve 170 should be avoided in embodiments without rollers 410, 411, (FIG. 4) or equivalents thereto. Spring assembly 718 smooths out impulsive forces applied to the cable 714 when a change of position is initiated. The impulsive force is stored in the deformation of the springs 730 (FIG. 7B) in the spring assembly 718.

Referring to FIG. 7B, an exemplary embodiment of spring assembly 718 is shown comprising two leaf springs 730, as are used in automobile suspensions, connected at their ends by parts 731. Parts 731 may each be a pair of bars, connecting the ends of leaf springs in the conventional way. The cable 714 attaches to the middle of the top leaf spring 730, while the middle of the bottom leaf spring 730 is bolted to mast sleeve extension 171. When the tension in the cable 714 increases, the springs 730 deform and then return to the natural shape as the mast sleeve extension 171, mast sleeve 170 and all attached thereto rises into position. The present invention contemplates a wide variety of springs 730 and spring assemblies 718.

In an alternate embodiment, the hydraulic cylinder 710 may be oriented vertically and act directly on the mast sleeve 170. In other alternate embodiments, the hydraulic cylinder may be oriented vertically and act directly on the pivot axle 150, with or without a mast 180.

FIG. 8 shows a mast sleeve 170 having flanges 810 to which hydraulic pistons 816 are rotationally engaged. Hydraulic cylinders 812, which actuate hydraulic pistons 816, are rotationally engaged to center section 102 by means of a coupling 814. Responsive to operator input, the pistons 812 either move freely or exert sufficient force to lock the center section 102, and boom 135 entirely, into a fixed position with respect to the mast 180. During spraying operations, the pistons 812 exert only a small damping force, allowing the boom 135 to swing on the pendulum arm 140 relative to mast 180. When turning the vehicle 190 (FIG. 1A) around at the end of a row of crops, the boom 135 is locked in place by pistons 812 to prevent oscillations induced by vehicle 190 movement.

FIG. 9A shows an exemplary mechanical linkage 900 for swinging the spray booms 130 in concert between operational and storage or maneuvering positions. Bar 930 rotates about pivot 935 mounted on beam 104 of center section 102. The rotation of bar 930 is controlled by two hydraulic actuators 920, which act in concert. Hydraulic actuators 920 are pivotally mounted to the center section 102 by rotational mounts 940 and pivotally mounted to bar 930 by rotational mounts 936. When the hydraulic actuators 920 rotate the bar 930, tie rods 910 push or pull the spray booms 130 into position. Each tie rod 910 is connected to bar 930 by a cup and ball joint 934, and to a leaf spring 914 by cup and ball joint 912.

FIG. 9B shows a top view of exemplary mechanical linkage 900. Leaf springs 914 extend from rigid attachments to spray booms 130 and engage tie rods 910 through cup and ball joints 912. When tie rods 910 are pushed outward, spray booms 130 rotate about axles 120 to fold to the storage position. When tie rods 910 are later pulled inward, spray booms 130 are extended to the operational position. Hydraulic actuators may be controlled from a common source of hydraulic fluid pressure to ensure action in concert. Those of skill in the art will appreciate that tie rods 910 and leaf springs 914 may be salvaged from automobiles.

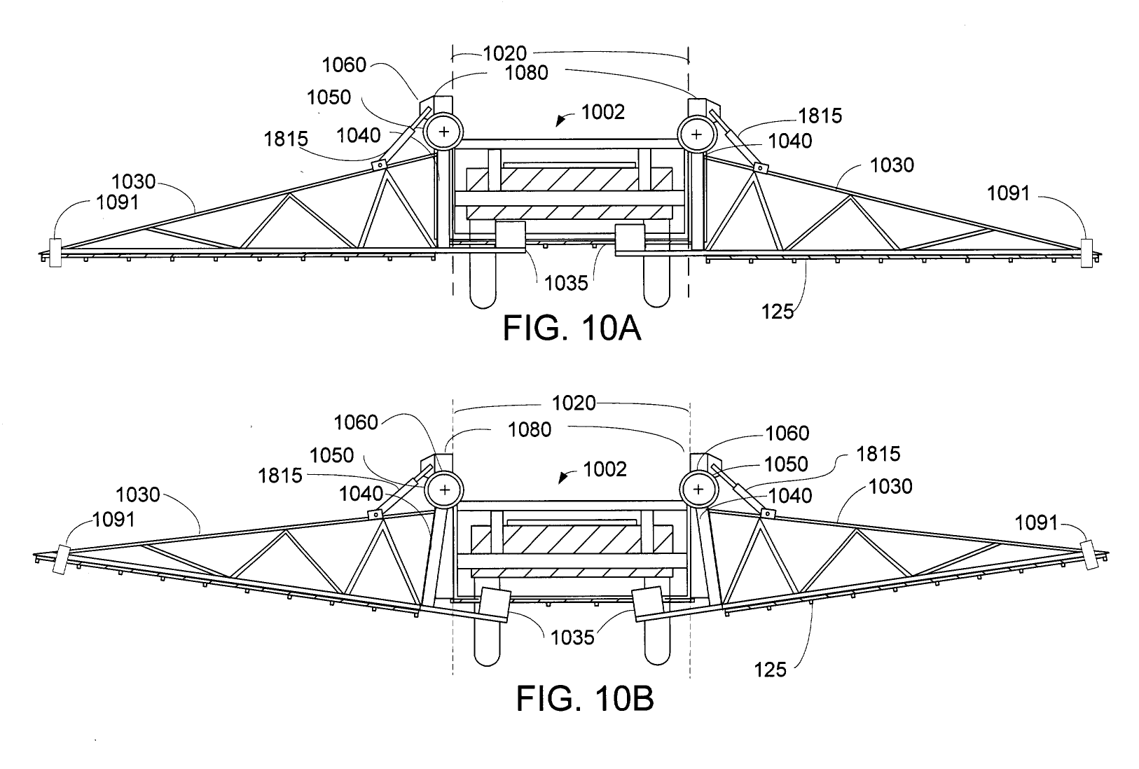

FIG. 10A shows an exemplary dual-pendulum embodiment of the crop spraying device. The center section 1002 may be rigidly attached to the vehicle 190 (FIG.3C). In an alternate embodiment, the center section may be mounted on a pendulum arm structure 145 (FIG. 2). In another alternate embodiment, pivot axles may be mounted on a mast sleeve 170 (FIG. 1B). At the outward sides of center section 1002 are flexibly mounted masts 1080, to which pivot axles 1050 may be attached directly. The flexible mount allows the spray booms 1030, along with the masts 1080 and the pendulum arms 1040 to fold for transport, storage, and maneuver. Pivot sleeves 1060, having pendulum arms 1040 attached, rotationally engage pivot axles 1050. Spray booms 1030 are attached to pendulum arms 1040. Each spray boom 1030 has a counterweight 1035 to provide an unbiased balance about the pivot axis 1055. In an alternate embodiment, the counterweight may be another spray boom 1030, and center section 1002 may be articulated to aid in folding the spray booms 1030 for transport, storage, or maneuver.

A fluid transfer tilt-biasing system, as discussed above under FIG. 6, may be used to independently tilt-bias each of the spray booms 1030. In an embodiment, counterweights 1035 may be part of the fluid transfer tilt-biasing system. For example, counterweights 1035 may contain or support chambers for holding fluid. In a particular embodiment, counterweights 1035 may be shaped similarly to tubes 110 and 111 (FIG. 1D) to contain the transfer fluid. Tubes 1091 may be used as the second fluid container in the fluid transfer system. Hydraulic locks 1815 are used to fix spray booms 1030 in place relative to the masts 1080 (i.e., lock the pendulums) during turning maneuvers, storage, and transport. Hydraulic locks 1815 otherwise move freely during spraying operations. Hydraulic locks 1815 may provide some damping of pendulum oscillation when unlocked.

FIG. 10B shows the exemplary embodiment of FIG. 10A with the spray booms 1030 independently tilt-biased.

While the invention has been particularly shown and described with reference to exemplary embodiments thereof, it will be understood by those skilled in the art that changes in form and details may be made therein without departing from the spirit and scope of the invention. For example, avoiding harmonics with the frequency of spray sloshing in the spray tank may be added. Accordingly, unless otherwise specified, any dimensions of the apparatus indicated in drawings or herein are given as an example of possible dimensions and not as a limitation. Similarly, unless otherwise specified, any sequence of method steps indicated herein is given as an example of a sequence and not as a limitation.

1. An apparatus for spraying crops, adapted to be mounted on a vehicle, the apparatus comprising:
a pendulum support structure comprising a mast, a mast sleeve adjustably engaging the mast, and a pivot axle attached to the mast sleeve, the pivot axle defining a pivot axis, the pendulum support structure adapted to be mounted on a vehicle;
a pendulum arm structure, comprising a pivot sleeve rotationally engaged on the pivot axle, and a pendulum arm, coupled to and depending from the pivot sleeve, the pendulum arm having a center of mass;
a crop-spraying boom configured to be coupled to the pendulum arm structure, wherein the crop-spraying boom comprises a pendulate mass of a pendulum, said crop-spraying boom having a center of mass, wherein further the pendulum has a pendulum length, the pendulum length comprising the distance between the pivot axis and the combined center of mass of the crop-spraying boom and the pendulum arm, the pendulum length defining a pendulum frequency;
wherein the apparatus is configured to avoid harmonic coupling between the under-damped oscillations of any two of the pendulum, the crop-spraying boom, structural portions of the crop-spraying boom, a suspension system of the vehicle, a volume of spray sloshing in a spray tank, and a spray pump.

2. The apparatus of claim 1, wherein the pivot axis comprises an axis generally parallel to a roll axis of the vehicle.

3. The apparatus of claim 2, wherein the pivot axis comprises an axis generally co-linear to a roll axis of the vehicle.

4. The apparatus of claim 1, further comprising a mast sleeve adjustment mechanism, the mechanism comprising a hydraulic piston configured to move the mast sleeve up or down the mast, responsive to operator input.

5. The apparatus of claim 4, wherein the mast sleeve adjustment mechanism further comprises:
a pulley attached to a top of the mast; and
a cable connected between the hydraulic piston and a spring assembly attached to the top of a mast sleeve extension, the cable routed over the pulley;
wherein the point at which the spring assembly attaches to the mast extension is selected to provide a counterbalancing torque to a binding torque produced by the mass of the drop-spraying boom on the mast sleeve, the counterbalancing torque operative to unbind the mast sleeve from the mast;
wherein a first action of the hydraulic piston puts tension in the cable to unbind and lift the mast sleeve, the pendulum arm structure, and the crop-spraying boom engaged to the pendulum arm structure.

6. The apparatus of claim 1, wherein at least one of the lengths of the pivot sleeve and the pivot axle and the meeting diameters of the pivot sleeve and the pivot axle are selected to provide at least one of viscous rotational damping and a frictional rotational damping.

7. The apparatus of claim 1, further comprising hydraulic locks connecting the crop-spraying boom to the mast sleeve, the locks responsive to operator input to either lock the crop-spraying boom in position relative to the mast or to allow the crop-spraying boom to swing on the pendulum.

8. The apparatus of claim 1, wherein the crop-spraying boom comprises a plurality of sections, the sections adapted to be linearly aligned and engaged.

9. The apparatus of claim 8, wherein the crop-spraying boom comprises:
a center section having first and second ends;
first and second spray booms flexibly attached to respective first and second ends of the center section, the first and second spray booms comprising truss structures and spray plumbing, the spray booms each having principal modal vibration frequencies; and
at least one coupling mechanism for coupling the crop-spraying boom to the pendulum arm structure.

10. The apparatus of claim 9, further comprising an extension to each spray boom, the extension comprising a spray plumbing pipe, the spray plumbing pipe suspended by a cable, the cable supported by a suspension mast mounted on the spray boom, the cable anchored on the spray boom.

11. The apparatus of claim 10, further comprising a tube circumferentially engaging each extension, each tube at least partially filled with a fluid, a fluid transfer pump fluidically connected to a fluid transfer line between the tubes, the pump responsive to operator input and operable to transfer fluid between tubes to tilt bias the boom.

12. The apparatus of claim 11, wherein the tube comprises an inner tube.

13. The apparatus of claim 10, further comprising a substantially rigid beam, the beam parallel to and attached to the spray plumbing, the beam suspended by the cable.

14. The apparatus of claim 9, wherein the center section comprises at least one member, configured to be coupled to the pendulum arm.

15. The apparatus of claim 14, wherein the coupling to the pendulum arm comprises a pendulum arm sleeve, a position of the pendulum arm sleeve axially adjustable along the pendulum arm, the adjustment operative to adjust the pendulum length.

16. The apparatus of claim 15, wherein the apparatus further comprises a linkage between the pendulum arm sleeve and a mast sleeve adjustment mechanism, the linkage responsive to an adjustment in position of the crop-spraying boom on the pendulum arm and the linkage operable to move the mast sleeve on the mast to maintain a substantially constant height of the crop-spraying boom above the ground, wherein the link comprises at least one of an electrical, electronic, hydraulic, and mechanical link

17. The apparatus of claim 16, wherein the adjustable pendulum arm sleeve and the mast sleeve adjustment mechanism each comprise a rack and a worm gear engaging the rack, a mast worm gear mounted at least one of on and in the mast sleeve and a pendulum arm worm gear mounted at least one of on and in the pendulum arm sleeve, wherein the worm gears are driven by at least one of a motor and manually.

18. The apparatus of claim 9, wherein first spray boom has principal modal frequencies which are not harmonic with principal modal frequencies of the second spray boom.

19. The apparatus of claim 9, wherein first and second spray booms further comprise a mechanical linkage between the first and second spray booms, the mechanical linkage operative to flex the spray booms in concert between stored and operational positions.

20. The apparatus of claim 19, wherein the mechanical linkage comprises a hydraulically actuated mechanical linkage exerting a force through a leaf spring.

21. The apparatus of claim 9, wherein the principal modal vibration frequencies of each spray boom are not harmonic with the pendulum frequency, a vehicle suspension frequency, a spray tank slosh frequency, and a spray pump frequency.

22. The apparatus of claim 1, wherein the pendulum arm structure comprises a mechanism for adjusting the position of the crop-spraying boom on the pendulum arm, operative to change the pendulum length.

23. The apparatus of claim 1, further comprising a pump, the pump fluidly connected between first tube and a second tube, each tube attached to the crop-spraying boom, the pump adapted to transfer fluid between first and second tubes, the fluid transfer operative to alter the center of mass of the crop-spraying boom to achieve a tilt bias of the crop-spraying boom.

24. The apparatus of claim 23, further comprising a mechanism for adjusting the distance between the pivot axis and the crop-spraying boom responsive to a change in the center of mass of the crop-spraying boom and operable to maintain the pendulum length.

25. The apparatus of claim 1, wherein the pendulum length is held constant, and vibrations from at least one of a vehicle suspension, a volume of spray sloshing in a spray tank, and a sprayer pump are damped at the frequency corresponding to the pendulum length.

26. A method for adjusting a pendulum length for a pendulum crop-spraying boom, the position of the crop-spraying boom on a pendulum arm being variable, the crop-spraying boom comprising spray plumbing, the method comprising the steps of:
determining the modal vibration frequencies of the boom when the spray plumbing is full;
calculating the harmonics of the modal vibration frequencies of the crop-spraying boom within the range of possible pendulum frequencies;
determining gaps in the crop-spraying boom principal modal vibration frequency harmonics within the range of possible pendulum frequencies; and
positioning the crop-spraying boom on the pendulum arm to obtain a pendulum length which produces a natural pendulum frequency within a gap in the crop-spraying boom principal modal vibration frequency harmonics.

27. The method of claim 26, wherein the step of determining the modal vibration frequencies of the boom when the spray plumbing is full comprises at least one of the steps of structural analysis and field testing.

28. The method of claim 27, wherein the step of field testing comprises the steps of:
making the pendulum arm unmoveable;
applying an impulse to an end of the crop-spraying boom; and
recording the frequency of the resulting oscillation of the crop-spraying boom.

29. A pendulate crop-spraying device comprising:
a boom, comprising
a center section, comprising:
a frame, comprising:
a plurality of beams arranged and connected to form the frame, the frame having modal vibration frequencies;
a mechanism for coupling at least one beam with a pendulum arm; and
first and second ends, comprising:
engagement mechanisms for flexibly engaging spray booms; and
the first and second spray booms, each comprising:
a truss;
at least one engagement mechanism for flexibly engaging the center section;
first and second spray plumbing, each comprising spray tubing and spray nozzles, the spray plumbing adapted to be connected to the center spray plumbing; and
a plurality of modal vibration frequencies; and
a pendulum arm structure, comprising;
the pendulum arm, the arm having a length, the length defining a pendulum frequency, the arm adapted to be coupled to the frame of the center section; and
a pivot sleeve coupled with the pendulum arm, the pivot sleeve sized and shaped to rotationally, slidingly, and dampingly engage a pivot axle; and
a pendulum support structure, comprising:
a mast, the mast comprising a vertical elongated member having a base end and a top end, the base end attached to the vehicle;
a slidingly adjustable mast sleeve engaging the mast at a height above the base end; and
a pivot axle attached to and extending from the mast sleeve, the pivot axle adapted to receive the pivot sleeve of the pendulum arm structure;
wherein the frequency of the pendulum is not harmonic with at least one of a modal vibration frequency of the center section, a modal vibration frequency of the spray booms, a modal vibration frequency of the combination of the center section and the spray booms, a vehicle suspension frequency, a spray tank slosh frequency, and a spray pump frequency.

30. The crop-spraying device of claim 29, wherein the center section further comprises a fluidic mechanism, independent of the spray plumbing, operative to shift the center of mass of the boom, the shifted center of mass resulting in a tilt bias of the boom.

31. The crop-spraying device of claim 30, wherein the fluidic mechanism comprises a passive viscous rotational damper, configured as at least two tubes between which a viscous fluid is controllably transferred, each tube containing at least one ball, the at least one ball operable to be worked upon by the viscous fluid in motion.

32. The crop-spraying device of claim 29, wherein the mechanism for coupling the pendulum arm with the center section frame adjustably couples the pendulum arm to the center section frame, the adjustable coupling configured to adjust the position of the center section frame on the pendulum arm.

33. The crop-spraying device of claim 32, wherein the adjustment of the coupling between the pendulum arm and the center section frame and the adjustment of the mast sleeve on the mast are coupled, the coupling of adjustments operative to change a pendulum length without changing the height of the boom above a crop.

34. The crop-spraying device of claim 29, wherein the first and second spray booms have different modal vibration frequencies.

35. The crop-spraying device of claim 29, further comprising center spray plumbing, wherein the center spray plumbing comprises spray tubing and spray nozzles, the spray tubing adapted to be connected to a supply of spray and further to be connected to spray plumbing on first and second spray booms.

36. A vehicle-mounted, pendulate-boom, crop-spraying apparatus configured to avoid harmonic vibration coupling between any two of the pendulum, a crop-spraying boom, structural portions of the crop-spraying boom, a suspension system of the vehicle, a volume of spray sloshing in a spray tank, and a spray pump.

37. The vehicle-mounted, pendulate-boom, crop-spraying apparatus of claim 36, further configured to damp crop-spraying boom oscillations using at least one of: a rotational frictional damper about the pivot axis of the pendulum; a rotational viscous damper about the pivot axis of the pendulum; and connected discrete structural portions of the boom having different modal vibration frequencies.

38. An apparatus for spraying crops, adapted to be mounted on a vehicle, the apparatus comprising:
at least one mechanism for raising and lowering at least one crop-spraying boom relative to the vehicle;
at least one pendulum arm suspending the at least one crop spraying boom from the mechanism, the pendulum arm having an adjustable length, the length changing responsive to at least one of operator input and an input from a second control system;
a first control system, responsive to a change in the length of the pendulum arm to actuate the mechanism to maintain a constant height of the at least one crop-spraying boom relative to the vehicle.

39. The apparatus of claim 38, further comprising a fluid transfer mechanism for tilt biasing the crop-spraying boom, responsive to operator input and operative to transfer fluid between two tubes to achieve a tilt bias.

40. The apparatus of claim 39, further comprising the second control system, the second control system responsive to a tilt-biasing of the boom to change the pendulum arm length to maintain a constant pendulum length.

41. The apparatus of claim 38, wherein the first control system and the second control system are integrated.

42. An apparatus for spraying crops, adapted to be mounted on a vehicle, the apparatus comprising:
a center section comprising a frame, the frame having a first end and a second end, the frame mounted on the vehicle;
a first pendulum pivot axle attached at the top of the first end and a second pendulum pivot axle attached at the top of the second end, the axles oriented horizontally and parallel to the direction of operational travel of the vehicle;
first and second pendulum arms pivotally engaged on the first and second axles, respectively;
first and second spray booms, each spray boom having a coupling at a first end proximal the center section and a tip end distal the center section, the first and second spray booms coupled to the first and second pendulum arms, respectively;
first and second counterweights attached to the first and second pendulum arms respectively, operable to balance the mass of the spray boom to bring the pendulum arms vertical in a quiescent state.

43. The apparatus of claim 42, further comprising first and second fluid transfer systems comprising:
first and second tubes on the first and second spray booms, respectively;
first and second chambers at least one of on and in the first and second counterweights, respectively; and
first and second fluid transfer pumps, responsive to operator control to transfer fluid between the first tube and the first chamber and between the second tube and the second chamber, respectively, the transfers operable to independently tilt bias the first and second spray booms.

44. The apparatus of claim 42, wherein the mounting of the frame on the vehicle comprises mounting the frame on a pendulum arm pivoting on an axle attached to a structure mounted on the vehicle.

45. The apparatus of claim 42, wherein the modal vibration bandwidths of the first and second spray booms do not overlap.
